(19) United States
(12) Patent Application Publication
(10) Pub. No.: US 2025/0328774 A1
(43) Pub. Date: Oct. 23, 2025

(54) METHOD AND SYSTEM FOR CALCULATING UNCERTAINTY OF DATA

(71) Applicant: SAMSUNG SDS CO., LTD., Seoul (KR)

(72) Inventors: Joon Ho LEE, Seoul (KR); Ju Ree SEOK, Seoul (KR); Ju Youn SON, Seoul (KR); Woo Seok JANG, Seoul (KR)

(73) Assignee: SAMSUNG SDS CO., LTD., Seoul (KR)

(21) Appl. No.: 19/077,447

(22) Filed: Mar. 12, 2025

(30) Foreign Application Priority Data
Apr. 17, 2024 (KR) 10-2024-0051109
Oct. 21, 2024 (KR) 10-2024-0144209

(51) Int. Cl. G06N 3/092; G06N 3/048

(52) U.S. Cl. CPC G06N 3/092; G06N 3/048

(57) ABSTRACT

A method and system for calculating uncertainty are provided. The method according to some embodiments may include obtaining a reward dataset, including a plurality of reward pairs corresponding to each of a plurality of response pairs, by inputting a response dataset, including the plurality of response pairs, into a model, selecting a metric corresponding to each of the plurality of response pairs to calculate the true preference probability, and calculating the true preference probability corresponding to each of the plurality of response pairs.

### CROSS-REFERENCE TO RELATED APPLICATIONS

This application claims priority from Korean Patent Application No. 10-2024-0051109 filed on Apr. 17, 2024, and Korean Patent Application No. 10-2024-0144209 filed on Oct. 21, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for calculating the uncertainty of data, and more specifically, to a method and system for calculating the uncertainty of response data in order to determine the actual preference for response data that reflects preferences.

### 2. Description of the Related Art

Discussions are ongoing regarding methods for optimizing language models using human feedback on responses generated by language models to enhance the reliability of language models.

Various techniques for preference-training language models using preference datasets that include user preference information on responses generated by language models have emerged and are being widely adopted. These techniques include methods such as Reinforcement Learning from Human Feedback (RLHF) and Direct Preference Optimization (DPO), which enable language models to generate responses to specific queries while taking user preferences into account.

In the process of preference-training a language model, among the responses to a specific query, a first response with high user preference is labeled as a chosen response, and a second response with low user preference is labeled as a rejected response. The language model is then trained using the labeled responses. Specifically, for example, if 80% of users prefer the first response and 20% prefer the second response, the first and second responses are labeled as the selected and rejected responses, respectively, and the language model is preference-trained using preference data that includes these labeled responses.

However, in the process of labeling responses to a specific query as selected or rejected responses, the actual preference for each response is not considered. For example, since the preference of the 20% of users who favor the second response is disregarded and only the first response is labeled as the chosen response, uncertainty may exist in the labeling of the preference data.

A language model that has been preference-trained using such preference data containing uncertainty may generate unintended responses to specific queries, resulting in degraded model performance.

Therefore, in the process of preference-training a language model, it is necessary to calculate the uncertainty of preference data in order to improve the performance of the language model.

### SUMMARY

An objective of the present disclosure is to provide a method for calculating the uncertainty of preference data used in training a language model and a computing system for performing the method.

Another objective of the present disclosure is to provide a method for constructing soft-labeled preference data while considering the uncertainty of preference data, and a computing system for performing the method.

Yet another objective of the present disclosure is to provide a method for calculating the preference probability of preference data used in the preference training of a language model and preference-training the language model based on the calculated preference probability, and a computing system for performing the method.

The objectives of the present disclosure are not limited to those mentioned above, and other objectives not explicitly stated will be clearly understood by those skilled in the art based on the following description.

According to an aspect of the present disclosure, there is provided a method for calculating uncertainty, performed by a computing system. The method may include obtaining a first reward dataset, including a first plurality of reward pairs corresponding to a first response pair and a second plurality of reward pairs corresponding to a second response pair, by inputting a response dataset, including the first and second response pairs, into a model, wherein each of the reward pairs included in the first reward dataset includes a first reward and a second reward, calculating, for each of the reward pairs included in the first reward dataset, a first probability that the first reward is greater than the second reward, obtaining a first reward distribution for the first plurality of reward pairs corresponding to the first response pair, and obtaining a second reward distribution for the second plurality of reward pairs corresponding to the second response pair, calculating a first uncertainty value for the first response pair based on the first reward distribution, and calculating a second uncertainty value for the second response pair based on the second reward distribution, calculating a second probability for the first response pair based on the first uncertainty value, and calculating a third probability for the second response pair based on the second uncertainty value, selecting a metric ensuring that the first probability matches an average of the second and third probabilities for the first response pair and calculating a preference probability corresponding to the first response pair based on the selected metric, wherein the second probability is calculated based on a ratio of a difference between the first and second rewards included in each of the first plurality of reward pairs to the first uncertainty value, and wherein the third probability is calculated based on a ratio of a difference between the first and second rewards included in each of the second plurality of reward pairs to the second uncertainty value.

In some embodiments, the calculating the preference probability corresponding to the first response pair based on the selected metric may include obtaining a first reward pair by inputting the first response pair into the model and calculating a third uncertainty value based on the selected metric, and the preference probability may be calculated based on a ratio of a difference between rewards included in the first reward pair to the third uncertainty value.

In some embodiments, the calculating the preference probability corresponding to the first response pair based on the selected metric may include scaling the selected metric to a predefined range.

In some embodiments, the obtaining the first reward dataset by inputting the response dataset into the model may include obtaining the first reward dataset by applying one of dropout or deep ensemble to the model.

In some embodiments, the metric may be one of a plurality of metrics, and the plurality of metrics may include aleatoric uncertainty, epistemic uncertainty, or balanced entropy.

In some embodiments, the second probability may be a sigmoid function value for ratio calculated for the first pair, and the third probability may be a sigmoid function value for ratios calculated for the second response pair.

In some embodiments, the model may have been trained through supervised learning using the response dataset, preference information for each of the first and second response pairs included in the response dataset, and a second reward dataset corresponding to the response dataset.

According to another aspect of the present disclosure, there is provided a system for calculating uncertainty. The system may include at least one processor and at least one memory storing instructions that, when executed by the at least one processor, cause the at least one processor to perform operations of obtaining a first reward dataset, including a first plurality of reward pairs corresponding to a first response pair and a second plurality of reward pairs corresponding to a second response pair, by inputting a response dataset, including the first and second response pairs, into a model, wherein each of the reward pairs included in the first reward dataset includes a first reward and a second reward, calculating, for each of the reward pairs included in the first reward dataset, a first probability that the first reward is greater than the second reward; obtaining a first reward distribution for the first plurality of reward pairs corresponding to the first response pair, and obtaining a second reward distribution for the second plurality of reward pairs corresponding to the second response pair, calculating a first uncertainty value for the first response pair based on the first reward distribution, and calculating a second uncertainty value for the second response pair based on the second reward distribution, calculating a second probability for the first response pair based on the first uncertainty value, and calculating a third probability for the second response pair based on the second uncertainty value, selecting a metric ensuring that the first probability matches an average of the second and third probabilities for the first response pair and calculating a preference probability corresponding to the first response pair based on the selected metric, wherein the second probability is calculated based on a ratio of a difference between the first and second rewards included in each of the first plurality of reward pairs to the first uncertainty value, and wherein the third probability is calculated based on a ratio of a difference between the first and second rewards included in each of the second plurality of reward pairs to the second uncertainty value.

In some embodiments, the operation of calculating the preference probability corresponding to the first response pair based on the selected metric may include obtaining a first reward pair by inputting the first response pair into the model and calculating a third uncertainty value based on the selected metric, and the preference probability is calculated based on a ratio of a difference between rewards included in the first reward pair to the third uncertainty value.

In some embodiments, the operation of calculating the preference probability corresponding to the first response pair based on the selected metric may include scaling the selected metric to a predefined range.

In some embodiments, the operation of obtaining the first reward dataset by inputting the response dataset into the model may include obtaining the first reward dataset by applying one of dropout or deep ensemble to the model.

In some embodiments, the metric may be one of a plurality of metrics, and the plurality of metrics may include aleatoric uncertainty, epistemic uncertainty, or balanced entropy.

In some embodiments, the second probability may be a sigmoid function value for ratio calculated for the first pair, and the third probability may be a sigmoid function value for ratios calculated for the second response pair.

In some embodiments, the model may have been trained through supervised learning using the response dataset, preference information for each of the first and second response pairs included in the response dataset, and a second reward dataset corresponding to the response dataset.

According to yet another aspect of the present disclosure, there is provided a non-transitory computer-readable recording medium storing a computer program, which, when executed by at least one processor, causes the at least one processor to perform obtaining a first reward dataset, including a first plurality of reward pairs corresponding to a first response pair and a second plurality of reward pairs corresponding to a second response pair, by inputting a response dataset, including the first and second response pairs, into a model, wherein each of the reward pairs included in the first reward dataset includes a first reward and a second reward, calculating, for each of the reward pairs included in the first reward dataset, a first probability that the first reward is greater than the second reward, obtaining a first reward distribution for the first plurality of reward pairs corresponding to the first response pair, and obtaining a second reward distribution for the second plurality of reward pairs corresponding to the second response pair, calculating a first uncertainty value for the first response pair based on the first reward distribution, and calculating a second uncertainty value for the second response pair based on the second reward distribution, calculating a second probability for the first response pair based on the first uncertainty value, and calculating a third probability for the second response pair based on the second uncertainty value, selecting a metric ensuring that the first probability matches an average of the second and third probabilities for the first response pair and calculating a preference probability corresponding to the first response pair based on the selected metric, wherein the second probability is calculated based on a ratio of a difference between the first and second rewards included in each of the first plurality of reward pairs to the first uncertainty value, and wherein the third probability is calculated based on a ratio of a difference between the first and second rewards included in each of the second plurality of reward pairs to the second uncertainty value.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram illustrating the structure of a question-answering system according to an embodiment of the present disclosure;

FIG. 2 is a diagram illustrating the detailed structure of a question-answering system according to an embodiment of the present disclosure;

FIG. 3 is a flowchart illustrating the operation of a question-answering system according to some embodiments of the present disclosure;

FIG. 4 is a flowchart illustrating a method for calculating the uncertainty of data according to an embodiment of the present disclosure;

FIG. 5 is a flowchart illustrating an example of how to calculate a preference probability according to some embodiments of the present disclosure; and

FIG. 6 is a block diagram illustrating an exemplary computing device for performing some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of the present disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

In the present disclosure, “/” and “,” should be interpreted as “and/or.” For example, “A/B” and “A, B” may mean “A and/or B.”

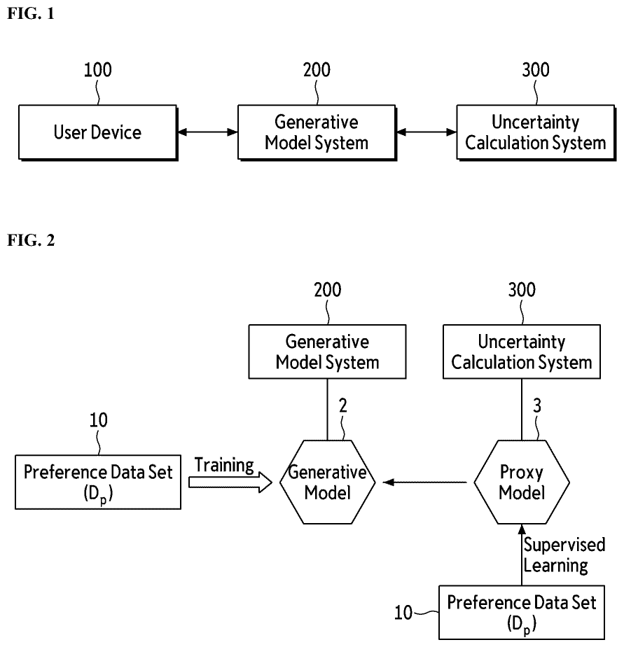

FIG. 1 is a diagram illustrating the structure of a question-answering system according to an embodiment of the present disclosure.

The question-answering system of FIG. 1 may provide a question-answering service that analyzes user-input queries and generates responses to the user-input queries, according to some embodiments of the present disclosure. For example, the question-answering system of FIG. 1 may receive at least one query from a user and generate or output at least one response to the input query using one or more models.

Referring to FIG. 1, the question-answering system may include a user device 100, a generative model system 200, and/or an uncertainty calculation system 300.

The user device 100 may include various devices used by the user to transmit and receive various data and/or information while communicating with other devices. The user device 100 may include a smartphone, tablet PC, and laptop, but is not limited thereto. For example, the user device 100 may include various computing devices equipped with wireless communication means and/or computing means. The user device 100 may be referred to as a user terminal, wireless device, mobile terminal, or portable device.

Here, the user may refer to a person who utilizes the question-answering service provided by the question-answering system using the user device 100. For example, the user may input a specific query through the user device 100 and acquire a response to the input query via a generative model according to some embodiments of the present disclosure.

A “query” may be referred to as a question or context and may include various forms of text such as words, sentences, and/or their combinations, and a response generated by a language model or the generative model for a specific query may also include various forms of text.

The user device 100 may be used to access the generative model system 200 and/or the uncertainty calculation system 300. For example, the user device 100 may display a user interface that implements the functions of the generative model system 200 and/or the uncertainty calculation system 300.

The generative model system 200 may generate a response to a specific query using the generative model. For example, the generative model system 200 may generate a prompt based on a query input by the user through the user device 100 and generate a response to the input query by inputting the generated prompt into the generative model. The generative model system 200 may then provide the generated response to the user through the user device 100.

Here, the generative model is an artificial intelligence (AI)-based model trained on various forms of text and may be referred to as a large-scale language model (LLM), a generative AI model, a question-answering model, or a conversational model.

The generative model system 200 may perform preference training on the generative model using a preference dataset. The generative model system 200 may apply a preference probability calculated according to some embodiments of present disclosure to each piece of preference data included in the preference dataset, thereby performing preference training on the generative model using a preference dataset that reflects the uncertainty of preference data. For example, a loss function may be configured by reflecting calculated preference probabilities, and the generative model may be preference-trained based on the loss function. Alternatively, the preference dataset may be sorted based on calculated preference probabilities, and the generative model may be preference-trained using the sorted preference data.

The generative model system 200 may perform preference training on the generative model using a proxy model according to embodiments of the present disclosure. The proxy model is a model that receives a response to a specific query as input and outputs a reward for the received response. For example, the generative model system 200 may perform preference training on the generative model based on a predefined loss function in which the greater the difference between the reward for a chosen response and the reward for a rejected response in the preference dataset, the lower the loss.

The uncertainty calculation system 300 may calculate the uncertainty of each piece of preference data included in the preference dataset using the proxy model and calculate the preference probability of each piece of preference data based on the calculated uncertainty.

Here, the preference dataset may be used as a training dataset for the pre-training of the proxy model, an input dataset for inference using the proxy model, and an input dataset for the preference training of the generative model.

Each piece of preference data included in the preference dataset may include responses to a specific query and user preference information corresponding to each of the responses. Preference data may include a response labeled as a response with high user preference and a response labeled as a response with low user preference.

Here, the response with high user preference is referred to as a chosen response, and the response with low user preference is referred to as a rejected response.

In describing embodiments of the present disclosure, for convenience, preference data corresponding to a specific query is illustrated as including a pair of responses consisting of a chosen response and a rejected response, but the present disclosure is not limited thereto. Preference data may include two or more responses to a specific query, and each of the two or more responses may be labeled based on user preference. Additionally, it is to be noted that the present disclosure may also be applicable to preference data or a preference dataset that includes two or more responses to a specific query.

For example, the uncertainty calculation system 300 may input a preference dataset that includes a plurality of preference data, each composed of a query and a response pair of selected and rejected responses to the query, into the proxy model, thereby acquiring a reward dataset that includes a plurality of reward pairs corresponding to the response pairs of the plurality of preference data. In this case, each of the plurality of reward pairs may include two rewards corresponding to the selected and rejected responses of the corresponding preference data.

The uncertainty calculation system 300 may calculate the preference prediction accuracy of the proxy model based on the reward dataset obtained through the proxy model. The preference prediction accuracy of the proxy model may refer to the probability that when preference data including a response pair that comprises a chosen response and a rejected response is input into the proxy model, the reward for the chosen response is greater than the reward for the rejected response.

For example, the uncertainty calculation system 300 may calculate the preference prediction accuracy of the proxy model by calculating the probability that for each of the plurality of reward pairs corresponding to the plurality of preference data included in the reward dataset obtained through the proxy model, the reward corresponding to the chosen response is greater than the reward corresponding to the rejected response.

The uncertainty calculation system 300 may select a metric for calculating the uncertainty of each of the plurality of preference data included in the preference dataset. For example, the uncertainty calculation system 300 may select, from a predefined set of multiple metrics, a metric ensuring that the preference prediction accuracy and the average preference prediction confidence of the proxy model approximate or match. The selected metric may be the same or different for each piece of preference data.

The average preference prediction confidence of the proxy model may refer to the average of the preference prediction confidences for the plurality of preference data included in the preference dataset, and the preference prediction confidences for the plurality of preference data may be defined based on the preference probabilities for the plurality of preference data.

Additionally, the uncertainty calculation system 300 may be included in the generative model system 200.

The uncertainty calculation system 300 may calculate the uncertainty values of the plurality of preference data based on the selected metric and calculate preference probabilities corresponding to the plurality of preference data based on the calculated uncertainty values.

The uncertainty calculation system 300 may be implemented on at least one computing device. For example, all functions of the uncertainty calculation system 300 may be implemented on a single computing device. Alternatively, some functions may be implemented on a first computing device, while the remaining functions may be implemented on a second computing device. Additionally, a specific function of the uncertainty calculation system 300 may be implemented across multiple computing devices.

The components illustrated in FIG. 1 may communicate through various types of wired and wireless networks. The devices and/or systems according to the present disclosure may be applicable to a local area network (LAN), wide area network (WAN), mobile radio communication network, wireless broadband internet (WiBro), and other communication systems without limitation.

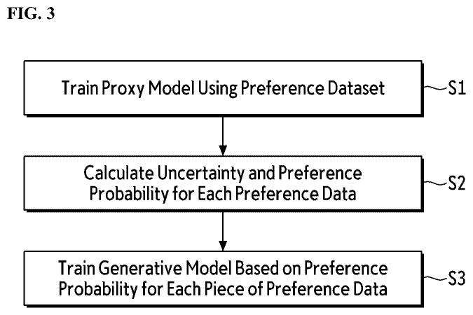

The preference probability of preference data according to the present disclosure will now be described with reference to FIG. 2.

FIG. 2 is a diagram illustrating a detailed structure of a question-answering system according to an embodiment of the present disclosure. A generative model system 200 and an uncertainty calculation system 300 in FIG. 2 may correspond to their respective counterparts in FIG. 1.

Referring to FIG. 2, the generative model system 200 may train a generative model 2 using a preference dataset 10 for preference training. As described above with reference to FIG. 1, the generative model system 200 may perform preference training on the generative model 2 using the proxy model 3.

The proxy model 3 may receive a response to a specific query as input and output a reward for the received response.

The generative model system 200 may provide a framework for reinforcement learning for the generative model 2 using the output of the proxy model 3. For example, the generative model system 200 may utilize the output of a proxy model pre-trained with the preference dataset 10 as a reward in the reinforcement learning framework and align the generative model 2 using a Reinforcement Learning from Human Feedback (RLHF) method.

In another example, the generative model system 200 may align the generative model 2 using a Direct Preference Optimization (DPO) method. Specifically, when the preference dataset 10 is denoted as Dₚ, a query as x, a chosen response for the query x as y_{c}, a rejected response for the query x as yᵣ, a target model to be aligned as π_{θ}, a reference model outputting a reference policy as π_{ref}, a reward for a response y as \hat{r}_{θ}, and a hyperparameter determining the KL-divergence penalty of a target policy with respect to the reference policy π_{ref}, as β, the generative model 2 may be aligned based on the objective defined as follows:

$${min}_{θ} - [ log σ ( {\hat{r}}_{θ} ( x , {y}_{c} ) - {\hat{r}}_{θ} ( x , {y}_{r} ) ) ] , \\ where {\hat{r}}_{θ} ( x , y ) = βlog \frac{{π}_{θ} ( y \vert x )}{{π}_{ref} ( y \vert x )} .$$

Here, each piece of preference data included in the preference dataset 10 may include a response pair labeled using a hard-labeling method, assuming that p(y_{c} [symbol] yᵣ|x)=1.0. For example, if 80% of users prefer a first response and 20% prefer a second response, the first response is labeled as the chosen response y_{c}, and the second response is labeled as the rejected response yᵣ. Preference data labeled in this hard-labeling manner does not reflect the true preference probability that accounts for the 20% of users who do not favor the first response (i.e., p*(y_{c} [symbol] yᵣ|x)=0.8). That is, the labels of preference data may contain uncertainty.

Therefore, when preference data containing hard-labeled ground-truth values is used as training data, the generative model 2 is preference-trained without reflecting the characteristics of the actual preference data.

In other words, preference data containing the response pair (y_{c}, yᵣ) that reflects user preferences for the query x may have uncertainty as training data for the generative model 2. The present disclosure proposes a method and system for calculating the uncertainty of preference data and estimating or calculating the true preference probability of the preference data based on the calculated uncertainty.

According to embodiments of the present disclosure, the uncertainty calculation system 300 may calculate the true preference probability (i.e., p*(y_{c} [symbol] yᵣ|x)) of hard-labeled responses included in preference data, thereby constructing preference data labeled using a soft-labeling method that reflects the true preference probability for each response.

Additionally, according to embodiments of the present disclosure, when performing preference training on the generative model 2 using the preference dataset 10, the performance of the generative model 2 may be improved by inputting each piece of preference data into the generative model 2 while reflecting the preference probability corresponding to each piece of preference data.

In the present disclosure, the preference dataset 10 may be referred to as a response dataset, and each piece of preference data included in the preference dataset 10 may be referred to as response data or a response pair.

For reference, the DPO method may be used to perform preference training on the generative model 2, but the present disclosure is not limited thereto. For example, the generative model system 200 may use various other methods such as a Rank Responses to Align Language Models with Human Feedback without Tears (RRHF) method or a Sequence Likelihood Calibration with Human Feedback (SLiC-HF) method to perform preference training on the generative model 2. Therefore, the uncertainty and/or preference probability corresponding to preference data, as calculated according to embodiments of the present disclosure, may be applicable to preference data used in preference training of the generative model 2 using methods such as RLHF, DPO, RRHF, and SLiC-HF.

The process of calculating the preference probability corresponding to each piece of preference data included in the preference dataset 10 and performing preference training on the is generative model 2 based on the calculated preference probability will now be described with reference to FIG. 3.

FIG. 3 is a flowchart illustrating the operation of a question-answering system according to some embodiments of the present disclosure.

FIG. 3 represents steps/operations performed in the generative model system 200 and/or the uncertainty calculation system 300 of FIG. 1. Accordingly, in the following description, if the subject performing a specific step/operation is omitted, it is to be understood that the specific step/operation is performed by the generative model system 200 and/or the uncertainty calculation system 300 of FIG. 1.

Referring to FIG. 3, first, the proxy model 3 may be trained using the preference dataset 10 (S1).

In step S1, the proxy model 3 may be trained through supervised learning using a preference dataset 10 that includes one or more preference data containing responses to a specific query and user preference information corresponding to the responses, along with a reward dataset that includes rewards set for the responses included in each piece of preference data.

In other words, the proxy model 3 may be trained through supervised learning based on a preference dataset 10 that includes a plurality of response pairs, each consisting of a chosen response and a rejected response, and a reward dataset that includes a plurality of reward pairs, each consisting of a first reward and a second reward assigned to the chosen response and the rejected response, respectively, within the corresponding response pair.

For example, if the proxy model 3 is denoted as r_{ϕ}, the proxy model 3 may be trained through supervised learning based on a ranking loss to learn the preference probability pattern of each of the response pairs included in the preference dataset 10. The ranking loss may is be defined as follows:

$${min}_{ϕ} - [ log σ ( {r}_{ϕ} ( x , {y}_{c} ) - {r}_{ϕ} ( x , {y}_{r} ) ) ] , ( σ : Sigmoid ) .$$

Thereafter, the uncertainty and preference probability corresponding to each piece of preference data included in the preference dataset 10 may be calculated (S2). In other words, the uncertainty and preference probability of each of the plurality of response pairs included in the preference dataset 10 may be calculated.

In step S2, by performing inference on the preference dataset 10 via the proxy model 3, the uncertainty of each response pair may be calculated based on the reward dataset, and the true preference probability of each response pair may be determined based on the calculated uncertainty. Specifically, the uncertainty and preference probability of each of the plurality of response pairs included in the preference dataset 10 may be calculated through the following steps.

In step S2, inference may be performed on the preference dataset 2 using the trained proxy model 3 by applying dropout sampling such as Monte Carlo dropout sampling.

Specifically, in step S2, each of the plurality of response pairs included in the preference dataset 10 may be input into the proxy model 3, and a corresponding reward pair may be output. The reward dataset obtained as the result of the inference may include a plurality of reward pairs, and each of the plurality of reward pairs may include a reward pair (r_{ϕ}(x, y_{c}) and r_{ϕ}(x, yᵣ)) corresponding to a response pair (y_{c}, yᵣ) included in the corresponding preference data.

Then, the distribution of the rewards included in the obtained reward dataset may be acquired, and the preference prediction accuracy of the proxy model 3 may be calculated based on the acquired distribution of the rewards.

Furthermore, based on the obtained reward dataset, a temperature r and preference prediction confidence corresponding to each of the plurality of response pairs included in the is preference dataset 10 may be calculated.

For example, if inference is performed by conducting Monte Carlo dropout sampling ten times, ten reward pairs corresponding to a first response pair included in the preference dataset 10 may be obtained. Based on the distribution of the ten reward pairs, including the reward pair (r_{ϕ}(x, y_{c}) and r_{ϕ}(x, yᵣ)) for the selected and rejected responses y_{c} and yᵣ, respectively, the mean and/or standard deviation of the rewards for the chosen response and the rewards for the rejected response may be calculated. Using the calculated mean and/or standard deviation, probability variables corresponding to the rewards for the chosen response and the rewards for the rejected response may be derived. The average preference prediction confidence for the first response pair may then be calculated based on the difference between the probability variables corresponding to the rewards for the chosen response and the rewards for the rejected response.

For example, in response to a single response pair (y_{c}, yᵣ) being input into the proxy model 3, a plurality of reward pairs may be output through sampling. In other words, a plurality of rewards

$$( {r}_{c}^{1} , … , {r}_{c}^{M} )$$

for the chosen response y_{c} and a plurality of rewards

$$( {r}_{r}^{1} , … , {r}_{r}^{M} )$$

for the rejected response yᵣ may be output. In this case, the plurality of reward pairs may be modeled as a Gaussian distribution, and probability variables R_{c} of the reward pairs corresponding to the chosen response y_{c} and Rᵣ of the reward pairs corresponding to the rejected response yᵣ may be derived. The uncertainty value (i.e., the temperature r) corresponding to the response pair (y_{c}, yᵣ) may be calculated based on a difference R between the probability variables R_{c} and Rᵣ. For example, the uncertainty value may be calculated based on the mean and/or standard deviation of the difference R.

The preference prediction confidence for the response pair (y_{c}, yᵣ) may be calculated based on the following formula:

$${( x , {y}_{c} , {y}_{r} )}_{} σ ( ( {r}_{ϕ} ( x , {y}_{c} ) - {r}_{ϕ} ( x , {y}_{r} ) ) / τ ) .$$

In other words, the preference prediction confidence for a single response pair may be calculated as the ratio of the difference between the reward for the chosen response and the reward for the rejected response to the uncertainty value corresponding to the single response pair.

For example, the preference prediction confidence for the response pair (y_{c}, yᵣ) may be calculated as σ((r_{c}−rᵣ)/τ), where r_{c} and rᵣ represent the mean values of

$$( {r}_{c}^{1} , … , {r}_{c}^{M} ) and ( {r}_{r}^{1} , … , {r}_{r}^{M} ) ,$$

Meanwhile, a metric ensuring the proper calibration of the proxy model 3 may be selected for providing the uncertainty of each response pair. That is, a metric for calculating the temperature r may be selected for each response pair such that the calculated preference prediction accuracy approximates or matches the average preference prediction confidence defined as follows:

$$[ σ ( ( {r}_{ϕ} ( x , {y}_{c} ) - {r}_{ϕ} ( x , {y}_{r} ) ) / τ ) ] .$$

Based on the selected metric for each response pair, the true preference probability p*(y_{c} [symbol] yᵣ|x) of each response pair may be estimated. The true preference probability p*(y_{c} [symbol] yᵣ|x) of each response pair may be defined as follows:

[symbol]

$${\hat{p}}^{*} ( {y}_{c} ≻ {y}_{r} \vert x ) = σ ( \frac{{r}_{ϕ} ( x , {y}_{c} ) - {r}_{ϕ} ( x , {y}_{r} )}{τ} ) .$$

For example, the metric used to provide the uncertainty value for calculating the preference probability of preference data may be one of aleatoric uncertainty, epistemic uncertainty, or balanced entropy.

In other words, the uncertainty value corresponding to each response pair may be calculated based on a metric such as aleatoric uncertainty, epistemic uncertainty, or balanced entropy. A metric ensuring proper calibration of the proxy model 3 may be selected, and may be used to estimate the true preference probability for each response pair.

Aleatoric uncertainty refers to uncertainty inherent in data due to noise. For example, if aleatoric uncertainty is selected as a metric for calculating uncertainty, the uncertainty of preference data may be determined by measuring the intrinsic variance (e.g., homoscedastic or heteroscedastic variance) of the preference dataset 10.

Epistemic uncertainty refers to uncertainty in model parameters. Epistemic uncertainty can be measured by modeling the probability distribution of input data over the model parameters using a Bayesian neural network (BNN). For example, if epistemic uncertainty is selected as the metric for calculating uncertainty, the uncertainty of preference data may be calculated based on the probability distribution of the preference dataset 10 over the parameters of the proxy model 3.

Balanced entropy refers to the balance of information between a model and labels. For example, if balanced entropy is selected as the metric for calculating uncertainty, the uncertainty corresponding to preference data may be calculated based on the ratio of joint entropy, which is derived from the posterior uncertainty, aleatoric uncertainty, and epistemic uncertainty of the proxy model 3 for an increased entropy in the proxy model 3.

The selected metric may differ from preference data to preference data, and the range of the temperature r produced by the selected metric may also vary. Therefore, the metric selected (or to be selected) for each piece of preference data may be scaled to a predefined range, and as a result, the temperature r to be produced by the selected metric may also be scaled to fall within the predefined range. For example, the temperature r may be normalized to fall within the range of 0 and 1.

In the present disclosure, calculating the uncertainty of each piece of preference data is (or response pair) may mean calculating the temperature r corresponding to each piece of preference data (or response pair).

For example, if exp(balanced entropy−1) is selected as the metric for calculating the temperature r, the temperature r may be expressed as the ratio of the difference between the reward for the rejected response and the reward for the chosen response to the logit of an estimated preference probability \hat{p}*, as indicated by the following formula:

$$τ := \frac{{r}_{ϕ} ( {y}_{r} ) - {r}_{ϕ} ( {y}_{c} )}{log it {\hat{p}}^{*}} = \frac{{r}_{ϕ} ( {y}_{r} ) - {r}_{ϕ} ( {y}_{c} )}{log {\hat{p}}^{*} - log ( 1 - {\hat{p}}^{*} )} ∈ [ 0 , 1 ] .$$

If the temperature r is defined as a value between 0 and 1, the temperature r may represent two different aspects. For example, when the estimated preference probability \hat{p}* is greater than 0.5 (the case where the probability that the chosen response is actually preferred is less than the probability that the chosen response is not preferred), the temperature r indicates a case where the reward for the chosen response is less than the reward for the rejected response. Conversely, when the estimated preference probability \hat{p}* is less than 0.5 (the case where the probability that the chosen response is actually preferred is greater than the probability that the chosen response is not preferred), the temperature τ indicates a case where the reward for the chosen response is greater than the reward for the rejected response. In other words, the temperature τ may indicate the degree of uncertainty in the labels of preference data, thereby representing the uncertainty of preference data.

According to embodiments of the present disclosure, an adaptive metric may be selected for each piece of preference data included in the preference dataset 10, and the uncertainty and true preference probability of each piece of preference data may be calculated based on the selected metric.

Thereafter, the generative model 2 may be subject to preference training (S3) based on the true preference probability p*(y_{c} [symbol] yᵣ|x) calculated for each piece of preference data in is step S2.

For example, in step S3, preference training for the generative model 2 may be performed using DPO, conservative DPO (cDPO) with label smoothing, and/or similar methodologies, based on the true preference probability calculated for each piece of preference data.

As a result, the generative model 2, trained with a preference dataset 10 reflecting true preferences, can generate responses closer to actual preferences compared to a model trained with a preference dataset that does not reflect the true preferences, thereby achieving higher performance.

For example, preference training for the generative model 2 may be performed based on the following training objective incorporating the true preference probability p*(y_{c} [symbol] yᵣ|x):

$${min}_{θ} - [ {p}^{*} ( {y}_{c} ≻ {y}_{r} \vert x ) log σ ( {\hat{r}}_{θ} ( x , {y}_{c} ) - {\hat{r}}_{θ} ( x , {y}_{r} ) ) ] .$$

In another example, alignment training for the generative model 2 may be performed using an interpolation-based method, based on the following training objective incorporating true preference probability (p*(y_{c}>yᵣ|x), p*):

$${min}_{θ} - [ {p}^{*} log σ ( {\hat{r}}_{θ} ( x , {y}_{c} ) - {\hat{r}}_{θ} ( x , {y}_{r} ) ) + ( 1 - {p}^{*} ) log σ ( {\hat{r}}_{θ} ( x , {y}_{r} ) - {\hat{r}}_{θ} ( x , {y}_{c} ) ) ] .$$

In yet another example, the true preference probability p*(y_{c}>yᵣ|x) may be utilized as a preference significance margin. Preference training for the generative model 2 may be performed based on the following training objective incorporating the true preference probability p*(y_{c}>yᵣ|x):

$${min}_{θ} - [ log σ ( {\hat{r}}_{θ} ( x , {y}_{c} ) - {\hat{r}}_{θ} ( x , {y}_{r} ) - {p}^{*} ( {y}_{c} ≻ {y}_{r} \vert x ) ) ]$$

In still another example, the true preference probability p*(y_{c}>yᵣ|x) may be utilized is for curation or curriculum planning of preference data.

For example, the preference dataset 10 may be sorted based on true preference probabilities and then used for training the generative model 2. The plurality of preference data included in the preference dataset 10 may be arranged in order, starting from preference data with higher information gain (i.e., with a lower p*(y_{c}>yᵣ|x)) to preference data with lower information gain (i.e., with a higher p*(y_{c}>yᵣ|x)).

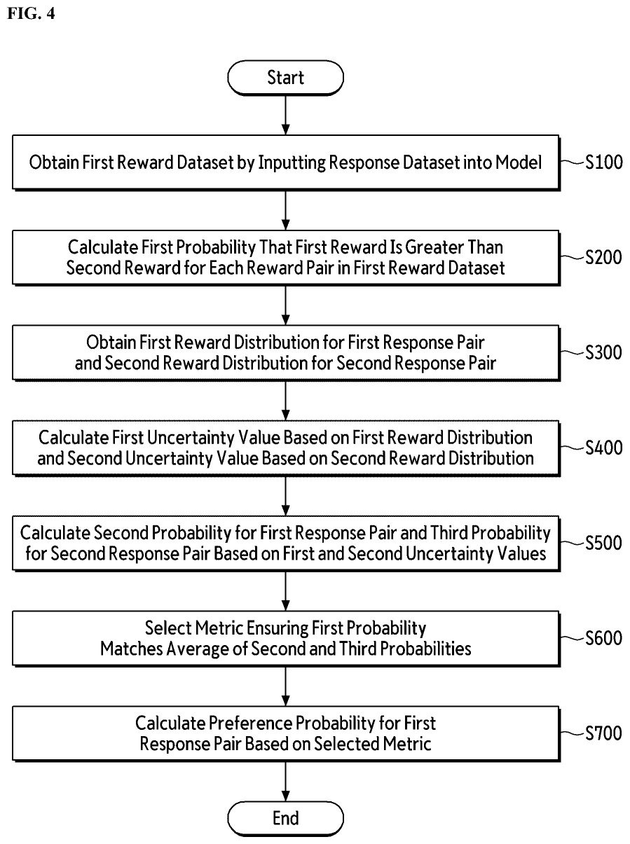

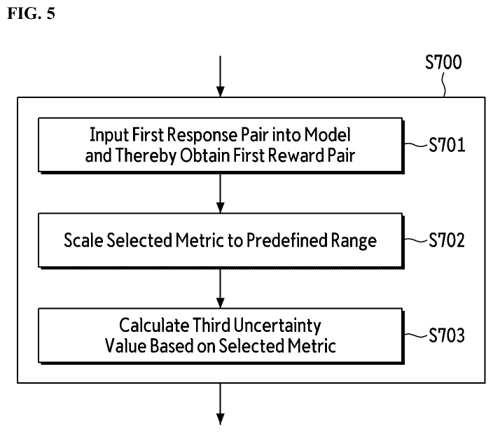

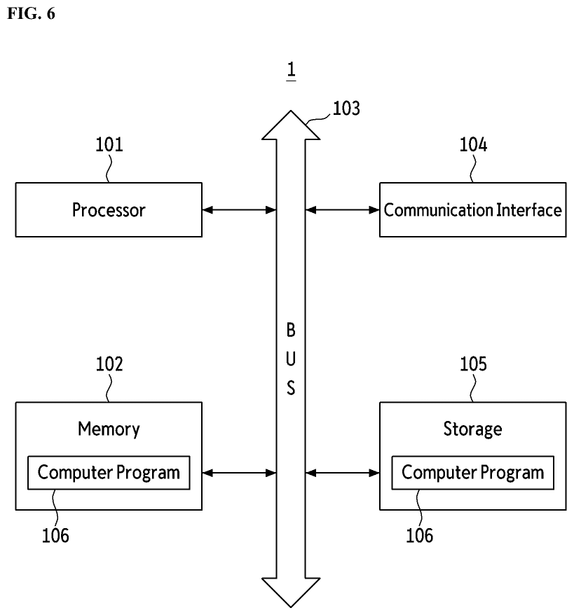

Embodiments for calculating the uncertainty and preference probability (p*(y_{c}>yᵣ|x)) of each piece of preference data in step S2 of FIG. 3 will now be described in detail with reference to FIGS. 4 and 5. For reference, FIGS. 4 and 5 represent steps/operations performed in the uncertainty calculation system 300 of FIG. 1. Accordingly, in the following description, if the subject performing a specific step/operation is omitted, it is to be understood that the specific step/operation is performed by the uncertainty calculation system 300 of FIG. 1. The description will now proceed with reference to FIGS. 2 through 7, along with FIGS. 1 and 2.

It should also be noted that the technical ideas derived from the embodiments of FIGS. 1 through 3 are also applicable to the embodiments of FIGS. 4 and 5.

FIG. 4 is a flowchart illustrating a method for calculating the uncertainty of data according to an embodiment of the present disclosure. Steps S100, S200, S300, S400, S500, S600, and S700 of FIG. 4 may correspond to step S2 of FIG. 3.

For ease of explanation, FIGS. 4 and 5 illustrate a response dataset including a first response pair and a second response pair, but the present disclosure is not limited thereto. That is, the embodiments of FIGS. 4 and 5 may also be applied to a response dataset including more than two response pairs.

Referring to FIG. 4, a response dataset including a first response pair and a second response pair may be input into a model, and a first reward dataset, including a first plurality of is reward pairs corresponding to the first response pair and a second plurality of reward pairs corresponding to the second response pair, may be obtained (S100). In other words, the first reward dataset may be obtained as a result of inference performed on the response dataset by the model.

In step S100, each of the reward pairs included in the first reward dataset may include a pair of rewards, i.e., first and second rewards.

Here, the first and second rewards may be the rewards for first and second responses, respectively, included in a corresponding response pair.

In step S100, the model may correspond to the proxy model 3 described with reference to FIG. 2.

In step S100, the model may already have been trained through supervised learning using the response dataset, user preference information for each response included in each of the first and second response pairs of the response dataset, and a second reward dataset corresponding to the response dataset.

For example, each of the first and second response pairs included in the response dataset may include a first response labeled as a chosen response and a second response labeled as a rejected response. The second reward dataset may include a plurality of reward pairs, each consisting of first and second rewards set for the first and second responses, respectively, included in the corresponding response pair.

In step S100, the first reward dataset may be obtained by applying one of dropout or a deep ensemble to the supervised-trained model. For example, a plurality of reward pairs corresponding to each of the first and second response pairs input into the model may be output by performing Monte Carlo dropout sampling.

For each of the plurality of reward pairs included in the first reward dataset, a first is probability that the first reward is greater than the second reward may be calculated (S200).

For example, if the first reward corresponds to the reward for a chosen response and the second reward corresponds to the reward for a rejected response, then in step S200, the probability that the model outputs a higher reward for a chosen response than for a rejected response may be calculated.

In step S200, the first probability may correspond to the preference prediction accuracy of the model.

The reward distribution for the first plurality of reward pairs corresponding to the first response pair, i.e., a first reward distribution, may be obtained, and the reward distribution for the second plurality of reward pairs corresponding to the second response pair, i.e., a second reward distribution, may be obtained (S300).

Thereafter, a first uncertainty value corresponding to the first response pair may be calculated based on the first reward distribution, and a second uncertainty value corresponding to the second response pair may be calculated based on the second reward distribution (S400).

Here, the uncertainty value corresponding to each of the first and second response pairs may be calculated based on a metric such as aleatoric uncertainty, epistemic uncertainty, or balanced entropy.

Thereafter, a second probability for the first response pair may be calculated based on the first uncertainty value, and a third probability for the second response pair may be calculated based on the second uncertainty value (S500).

In step S500, the second probability may be calculated based on the ratio of the difference between the first and second rewards in each of the first plurality of reward pairs to the first uncertainty value. Similarly, the third probability may be calculated based on the ratio of is the difference between the first and second rewards in each of the second plurality of reward pairs to the second uncertainty value.

In step S500, the second and third probabilities may correspond to the preference prediction confidences of the first and second response pairs, respectively.

For the first response pair, a metric may be selected that ensures that the first probability matches the average of the second and third probabilities (S600). Based on the selected metric, the preference probability corresponding to the first response pair may be calculated (S700).

In step S600, the average of the second and third probabilities may correspond to the average of the preference prediction confidences of the response pairs included in the response dataset.

In step S600, one of multiple metrics including aleatoric uncertainty, epistemic uncertainty, or balanced entropy may be selected for each of the first and second response pairs.

For example, as explained earlier with reference to FIG. 3, the second probability corresponding to the first response pair and the third probability corresponding to the second response pair may each be defined as the value of a sigmoid function applied to the ratio of the difference between the rewards to the uncertainty value for the corresponding response pair.

The process of calculating the preference probability of response data will now be described in detail with reference to FIG. 5.

Step S700 of FIG. 5 may correspond to step S700 of FIG. 4.

Referring to FIG. 5, in step S700, the first response pair may be input into the model, thereby obtaining a first reward pair (S701). Thereafter, a third uncertainty value may be is calculated (S703) based on the metric selected in step S600.

Here, the preference probability corresponding to the first response pair may be calculated based on the ratio of the difference between the rewards in the first reward pair to the third uncertainty value.

Here, the rewards refer to those for the selected and rejected responses included the reward pair obtained by inputting the first response pair into the model.

Additionally, the calculated preference probability may correspond to the true preference probability of each piece of response data, as described with reference to FIG. 3.

In some embodiments of the present disclosure, as illustrated in FIG. 4, the true preference probability of each response data (or response pair) included in the response dataset may be calculated. To this end, a metric for calculating uncertainty may be selected for each response data.

The selected metric may be either the same or different for each response data. If different metrics are selected for different response data, the range of the uncertainty values calculated for each response data may vary.

To reduce distortion caused by variations in uncertainty value ranges, the selected metric may be scaled to a predefined range, thereby normalizing the uncertainty values across the response data.

Referring to FIG. 5, in step S700, the selected metric may be scaled to a predefined range (S702). In this case, the uncertainty value calculated based on the scaled metric may be used to estimate or calculate the preference probability corresponding to the first response pair. In other words, the third uncertainty value corresponding to the first response pair may be calculated based on the selected metric that has been scaled to the predefined range.

FIG. 5 illustrates that the scaling of the selected metric is performed in step S700. However, the present disclosure is not limited to this, and the order in FIG. 5 is not limiting. For example, the metric selected for the first response pair in step S600 of FIG. 4 may already be a metric that has been scaled to a predefined range. Additionally, the second and/or third uncertainty values calculated in step S400 of FIG. 4 may have been calculated based on a metric that has been scaled to a predefined range.

FIG. 6 is an illustrative hardware configuration diagram illustrating the computing device 160.

Referring to FIG. 6, the computing device 1 may include at least one processor 101, a system bus 103, a communication interface 104, a memory 102, which loads a computer program 106 executed by the processor 101, and a storage 105, which stores the computer program 106. Even though FIG. 6 depicts only components related to the embodiments of the present disclosure, it is obvious to one of ordinary skill in the art to which the present disclosure pertains that the computing device 1 may further include other generic components, in addition to the components depicted in FIG. 6. Moreover, in some embodiments, the computing device 1 may be configured with some of the components depicted in FIG. 11 omitted. The components of the computing device 1 will hereinafter be described.

The processor 101 may control the overall operation of each of the components of the computing device 1. The processor 101 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 101 may perform computations for at least one application or program to execute operations/methods according to some embodiments of the present disclosure. The computing device 1 may be equipped with one or more processors.

The memory 102 may store various data, commands, and/or information. The memory 102 may load the computer program 166 from the storage 105 to execute the is operations/methods according to some embodiments of the present disclosure. The memory 102 may be implemented as a volatile memory such as a random-access memory (RAM), but the present disclosure is not limited thereto.

The bus 103 may provide communication functionality between the components of the computing device 1. The bus 103 may be implemented in various forms such as an address bus, a data bus, and a control bus.

The communication interface 104 may support wired or wireless Internet communication of the computing device 1. Additionally, the communication interface 104 may also support various other communication methods. To this end, the communication interface 104 may be configured to include a communication module well-known in the technical field of the present disclosure.

The storage 105 may non-transitorily store at least one computer program 106. The storage 105 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 106, when loaded into the memory 102, may include one or more instructions that enable the processor 101 to perform the operations/methods according to some embodiments of the present disclosure. That is, by executing the loaded one or more instructions, the processor 101 may perform the operations/methods according to some embodiments of the present disclosure.

For example, the computer program 106 may include instructions for: obtaining a first reward dataset, including a first plurality of reward pairs corresponding to a first response pair and a second plurality of reward pairs corresponding to a second response pair, by inputting a response dataset, including the first and second response pairs, into a model, wherein each of the reward pairs included in the first reward dataset includes a first reward and a second reward; calculating, for each of the reward pairs included in the first reward dataset, a first probability that the first reward is greater than the second reward; obtaining a first reward distribution for the is first plurality of reward pairs corresponding to the first response pair, and obtaining a second reward distribution for the second plurality of reward pairs corresponding to the second response pair; calculating a first uncertainty value for the first response pair based on the first reward distribution, and calculating a second uncertainty value for the second response pair based on the second reward distribution; calculating a second probability for the first response pair based on the first uncertainty value, and calculating a third probability for the second response pair based on the second uncertainty value; selecting, for the first response pair, a metric ensuring that the first probability matches the average of the second and third probabilities; and calculating the preference probability corresponding to the first response pair based on the selected metric. Here, the second probability may be calculated based on the ratio of the difference between the first and second rewards in each of the first plurality of reward pairs to the first uncertainty value, and the third probability may be calculated based on the ratio of the difference between the first and second rewards in each of the second plurality of reward pairs to the second uncertainty value.

According to the present disclosure, by calculating the uncertainty of preference data and the preference probability of the preference data based on the calculated uncertainty, a language model can be preference-trained while considering both the preference data and its uncertainty/preference probability. Consequently, the performance of the language model can be improved.

Various embodiments of the present disclosure and their effects have been described so far with reference to FIGS. 1 through 6. The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to is other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for calculating uncertainty, performed by a computing system, the method comprising:
obtaining a first reward dataset, including a first plurality of reward pairs corresponding to a first response pair and a second plurality of reward pairs corresponding to a second response pair, by inputting a response dataset, including the first and second response pairs, into a model, wherein each of the reward pairs included in the first reward dataset includes a first reward and a second reward;
calculating, for each of the reward pairs included in the first reward dataset, a first probability that the first reward is greater than the second reward;
obtaining a first reward distribution for the first plurality of reward pairs corresponding to the first response pair, and obtaining a second reward distribution for the second plurality of reward pairs corresponding to the second response pair;
calculating a first uncertainty value for the first response pair based on the first is reward distribution, and calculating a second uncertainty value for the second response pair based on the second reward distribution;
calculating a second probability for the first response pair based on the first uncertainty value, and calculating a third probability for the second response pair based on the second uncertainty value;
selecting a metric ensuring that the first probability matches an average of the second and third probabilities for the first response pair; and
calculating a preference probability corresponding to the first response pair based on the selected metric,
wherein the second probability is calculated based on a ratio of a difference between the first and second rewards included in each of the first plurality of reward pairs to the first uncertainty value, and
wherein the third probability is calculated based on a ratio of a difference between the first and second rewards included in each of the second plurality of reward pairs to the second uncertainty value.

2. The method of claim 1, wherein
the calculating the preference probability corresponding to the first response pair based on the selected metric comprises:
obtaining a first reward pair by inputting the first response pair into the model; and
calculating a third uncertainty value based on the selected metric, and
the preference probability is calculated based on a ratio of a difference between rewards included in the first reward pair to the third uncertainty value.

3. The method of claim 2, wherein the calculating the preference probability corresponding to the first response pair based on the selected metric comprises:
scaling the selected metric to a predefined range.

4. The method of claim 1, wherein the obtaining the first reward dataset by inputting the response dataset into the model comprises:
obtaining the first reward dataset by applying one of dropout or deep ensemble to the model.

5. The method of claim 1, wherein
the metric is one of a plurality of metrics, and
the plurality of metrics include aleatoric uncertainty, epistemic uncertainty, or balanced entropy.

6. The method of claim 1, wherein
the second probability is a sigmoid function value for ratio calculated for the first pair, and
the third probability is a sigmoid function value for ratios calculated for the second response pair.

7. The method of claim 1, wherein the model has been trained through supervised learning using the response dataset, preference information for each of the first and second response pairs included in the response dataset, and a second reward dataset corresponding to the response dataset.

8. A system for calculating uncertainty, the system comprising:
at least one processor; and
at least one memory storing instructions that, when executed by the at least one processor, cause the at least one processor to perform operations of:
obtaining a first reward dataset, including a first plurality of reward pairs corresponding to a first response pair and a second plurality of reward pairs corresponding to a second response pair, by inputting a response dataset, including the first and second response pairs, into a model, wherein each of the reward pairs included in the first reward dataset includes a first reward and a second reward;
calculating, for each of the reward pairs included in the first reward dataset, a first probability that the first reward is greater than the second reward; obtaining a first reward distribution for the first plurality of reward pairs corresponding to the first response pair, and
obtaining a second reward distribution for the second plurality of reward pairs corresponding to the second response pair;
calculating a first uncertainty value for the first response pair based on the first reward distribution, and calculating a second uncertainty value for the second response pair based on the second reward distribution;
calculating a second probability for the first response pair based on the first uncertainty value, and calculating a third probability for the second response pair based on the second uncertainty value;
selecting a metric ensuring that the first probability matches an average of the second and third probabilities for the first response pair; and
calculating a preference probability corresponding to the first response pair based on the selected metric,
wherein the second probability is calculated based on a ratio of a difference between the first and second rewards included in each of the first plurality of reward pairs to the first uncertainty value, and
wherein the third probability is calculated based on a ratio of a difference between the first and second rewards included in each of the second plurality of reward pairs to the second uncertainty value.

9. The system of claim 8, wherein
the operation of calculating the preference probability corresponding to the first response pair based on the selected metric comprises:
obtaining a first reward pair by inputting the first response pair into the model; and
calculating a third uncertainty value based on the selected metric, and
the preference probability is calculated based on a ratio of a difference between rewards included in the first reward pair to the third uncertainty value.

10. The system of claim 8, wherein the operation of calculating the preference probability corresponding to the first response pair based on the selected metric comprises:
scaling the selected metric to a predefined range.

11. The system of claim 8, wherein the operation of obtaining the first reward dataset by inputting the response dataset into the model comprises:
obtaining the first reward dataset by applying one of dropout or deep ensemble to the model.

12. The system of claim 8, wherein
the metric is one of a plurality of metrics, and
the plurality of metrics include aleatoric uncertainty, epistemic uncertainty, or balanced entropy.

13. The system of claim 8, wherein
the second probability is a sigmoid function value for ratio calculated for the first pair, and
the third probability is a sigmoid function value for ratios calculated for the second response pair.

14. The system of claim 8, wherein the model has been trained through supervised learning using the response dataset, preference information for each of the first and second response pairs included in the response dataset, and a second reward dataset corresponding to the response dataset.

15. A non-transitory computer-readable recording medium storing a computer program, which, when executed by at least one processor, causes the at least one processor to perform:
obtaining a first reward dataset, including a first plurality of reward pairs corresponding to a first response pair and a second plurality of reward pairs corresponding to a second response pair, by inputting a response dataset, including the first and second response pairs, into a model, wherein each of the reward pairs included in the first reward dataset includes a first reward and a second reward;
calculating, for each of the reward pairs included in the first reward dataset, a first probability that the first reward is greater than the second reward;
obtaining a first reward distribution for the first plurality of reward pairs corresponding to the first response pair, and obtaining a second reward distribution for the second plurality of reward pairs corresponding to the second response pair;
calculating a first uncertainty value for the first response pair based on the first reward distribution, and calculating a second uncertainty value for the second response pair based on the second reward distribution;
calculating a second probability for the first response pair based on the first uncertainty value, and calculating a third probability for the second response pair based on the second uncertainty value;
selecting a metric ensuring that the first probability matches an average of the second and third probabilities for the first response pair; and
calculating a preference probability corresponding to the first response pair based on the selected metric,
wherein the second probability is calculated based on a ratio of a difference between the first and second rewards included in each of the first plurality of reward pairs to the first uncertainty value, and
wherein the third probability is calculated based on a ratio of a difference between is the first and second rewards included in each of the second plurality of reward pairs to the second uncertainty value.
